(19) United States
(12) Patent Application Publication
(10) Pub. No.: US 2018/0182059 A1
(43) Pub. Date: Jun. 28, 2018

(54) INFORMATION PROCESSING APPARATUS AND COMMUNICATION CONTROL METHOD HAVING COMMUNICATION MODE BASED ON FUNCTION

(71) Applicant: Canon Kabushiki Kaisha, Tokyo (JP)

(72) Inventor: Ken Achiwa, Kashiwa-shi (JP)

(21) Appl. No.: 15/843,635

(22) Filed: Dec. 15, 2017

(30) Foreign Application Priority Data
Dec. 22, 2016 (JP) 2016-248960

(51) Int. Cl. G06T 1/20; H04N 1/00; H04N 1/32; H04N 1/40

(52) U.S. Cl. CPC G06T 1/20; H04N 1/0083; H04N 2201/0094; H04N 1/40; H04N 1/32358

(57) ABSTRACT

An information processing apparatus includes a plurality of processors, a communication unit, and a control unit. The plurality of processors forms a pipeline. The communication unit is configured to communicate data between the plurality of processors. The control unit is configured to assign a function to the plurality of processors. The control unit or the processors set a communication mode according to the function. The communication unit buffers the data in different buffer areas according to the communication mode, thereby communicating the data between the plurality of processors.

### BACKGROUND OF THE INVENTION

### Field of the Invention

One disclosed aspect of the embodiments relates to an information processing apparatus and a communication control method.

### Description of the Related Art

In a case where a single function is achieved using a plurality of processors, a method for improving system performance by the processors executing partial processes of the single function in parallel while transmitting and receiving a command to and from each other via a first-in-first-out (FIFO) buffer placed between the processors is known. Further, a method for achieving a plurality of functions in a multiplexed manner using the plurality of processors, by switching, in a time-sharing manner, programs to be assigned to the plurality of processors is also known.

The publication of Japanese Patent Application Laid-Open No. 2011-56703 discusses a technique for, according to the state of a FIFO buffer between processors, transferring data stored in the FIFO buffer to a system memory via a direct memory access (DMA) controller.

The technique in Japanese Patent Application Laid-Open No. 2011-56703, however, is a locally optimal control method capable of avoiding a full state and an empty state of the FIFO buffer, but is not necessarily a totally optimal control method capable of improving the system performance of a plurality of processors. That is, memory access by the DMA controller of the FIFO buffer and memory access by the plurality of processors conflict with each other and strain a memory band, thereby increasing a memory access waiting time (latency). This may reduce the system performance.

### SUMMARY OF THE INVENTION

According to an aspect of the embodiments, an information processing apparatus includes a plurality of processors, a communication unit, and a control unit. The plurality of processors forms a pipeline. The communication unit is configured to communicate data between the plurality of processors. The control unit is configured to assign a function to the plurality of processors. The control unit or the processors set a communication mode according to the function. The communication unit buffers the data in different buffer areas according to the communication mode, thereby communicating the data between the plurality of processors.

Further features of the present invention will become apparent from the following description of exemplary embodiments with reference to the attached drawings.

### BRIEF DESCRIPTION OF THE DRAWINGS

FIG. 1 is a block diagram illustrating an example of a configuration of a controller of an image processing apparatus.

FIG. 2 is a block diagram illustrating an example of an internal configuration of a general-purpose image processing unit.

FIG. 3 is a flowchart illustrating function execution control performed by a control unit.

FIG. 4 is a flowchart illustrating execution of a processing program by the general-purpose image processing unit.

FIG. 5 is a conceptual diagram illustrating function execution control of a function A.

FIG. 6 is a conceptual diagram illustrating function execution control of a function B.

FIG. 7 is a conceptual diagram illustrating function execution control of a function C.

FIG. 8 is a flowchart illustrating function execution control performed by a control unit.

FIG. 9 is a flowchart illustrating execution of a processing program by a general-purpose image processing unit.

FIG. 10 is a diagram illustrating correspondences between processing programs for the functions A to C and a method for controlling communication units.

### DESCRIPTION OF THE EMBODIMENTS

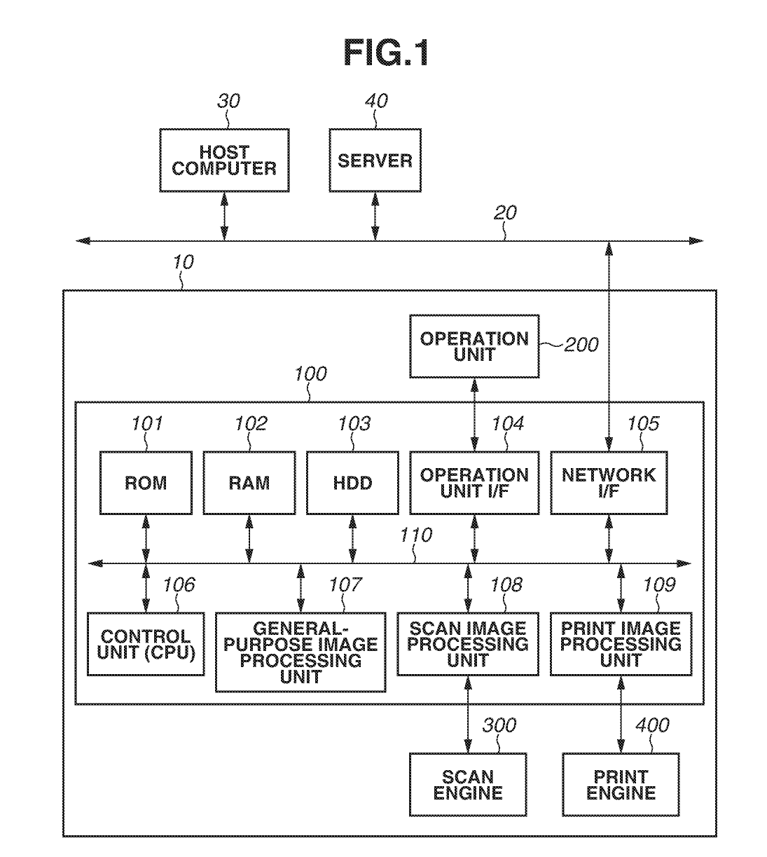

FIG. 1 is a block diagram illustrating an example of the configuration of an image processing system according to a first exemplary embodiment. The image processing system includes an image processing apparatus 10, a network 20, a host computer 30, and a server 40. The image processing apparatus 10 is an information processing apparatus and is, for example, a digital multifunction peripheral (MFP) having a plurality of functions such as a scan function, a print function, and a copy function.

The image processing apparatus 10 includes a controller 100, an operation unit 200, a scan engine 300, and a print engine 400 and is connected to the host computer 30 and the server 40 via the network 20. The network 20 is a local area network (LAN) or a wide area network (WAN) and is a communication unit for transmitting and receiving image data and device information between an external apparatus such as the host computer 30 or the server 40 and the image processing apparatus 10. The host computer 30 is a terminal on the network 20. Based on document data created by application software, the host computer 30 generates page description language (PDL) data of which the print output can be performed by the image processing apparatus 10, and transmits the generated PDL data. The server 40 is a terminal for receiving and temporarily storing PDL data generated by and transmitted from the host computer 30. According to an instruction to execute PDL printing from the operation unit 200 of the image processing apparatus 10, the server 40 transmits the PDL data to the image processing apparatus 10.

The controller 100 is a control unit connected to the network 20, the operation unit 200, the scan engine 300, and the print engine 400 and for controlling the entirety of the image processing apparatus 10. In the controller 100, a read-only memory (ROM) 101, a random-access memory (RAM) 102, a hard disk drive (HDD) 103, an operation unit interface (I/F) 104, and a network I/F 105 are connected to each other via a system bus 110. Further, in the controller 100, a central processing unit (CPU) 106, a general-purpose image processing unit 107, a scan image processing unit 108, and a print image processing unit 109 are connected to each other via the system bus 110.

The ROM 101 is a non-volatile memory and is a storage unit storing a boot program for the CPU 106 to start a system. The RAM 102 is a volatile memory such as a static random-access memory (SRAM) or dynamic random-access memory (DRAM) and is a storage unit used as a work area for the CPU 106 to operate on the system or used as a buffer area for primarily storing image data and command data. The HDD 103 is a hard disk drive and is a large-capacity storage unit for mainly storing image data within the image processing apparatus 10. The operation unit I/F 104 is an interface unit for transmitting and receiving input/output data between the operation unit 200 and the controller 100. The operation unit I/F 104 transfers an operation input from the operation unit 200 to the inside of the controller 100 or transfers a display output from the inside of the controller 100 to the operation unit 200. The network I/F 105 is, for example, a LAN card and is an interface unit for transmitting and receiving image data and device information between an external apparatus such as the host computer 30 or the server 40 and the image processing apparatus 10 via the network 20.

The CPU 106 is a control unit for controlling the controller 100 of the image processing apparatus 10. For example, when a color PDL printing process is performed, the CPU 106 performs control to interpret PDL data received via the network 20, convert the PDL data into drawing data (a display list (DL)) for forming a page, and store the drawing data in the RAM 102. Further, for example, when a monochrome copying process is performed, the CPU 106 performs control to store, in the RAM 102, image data received from the scan engine 300 via the scan image processing unit 108. The general-purpose image processing unit 107 is a general-purpose image processing unit capable of achieving a plurality of different functions in a time-sharing manner by switching programs to be executed based on an instruction from the CPU 106. For example, when a color PDL printing process is performed, the general-purpose image processing unit 107 is controlled to execute a program for achieving a drawing (raster image processing (RIP)) function. At this time, the general-purpose image processing unit 107 rasterizes drawing data (DL) in a vector format generated by the CPU 106 into image data in a raster format. Further, for example, when a monochrome copying process is performed, the general-purpose image processing unit 107 is controlled to execute a program for achieving an image editing process. At this time, the general-purpose image processing unit 107 acquires image data in a raster format on the RAM 102 and executes an image editing process such as an image filter process and a pixel count process on the image data. The scan image processing unit 108 is an image processing unit connected to the scan engine 300 and for performing image processing for correction according to the device characteristics of the scan engine 300 on image data input from the scan engine 300. The print image processing unit 109 is an image processing unit connected to the print engine 400 and for performing image processing for correction according to the device characteristics of the print engine 400 on image data and then outputting the image data to the print engine 400. The system bus 110 is a processing unit for connecting the processing units included in the controller 100 to each other, and transmitting and receiving image data and command data between the processing units. The scan engine 300 generates image data by scanning. The print engine 400 prints image data.

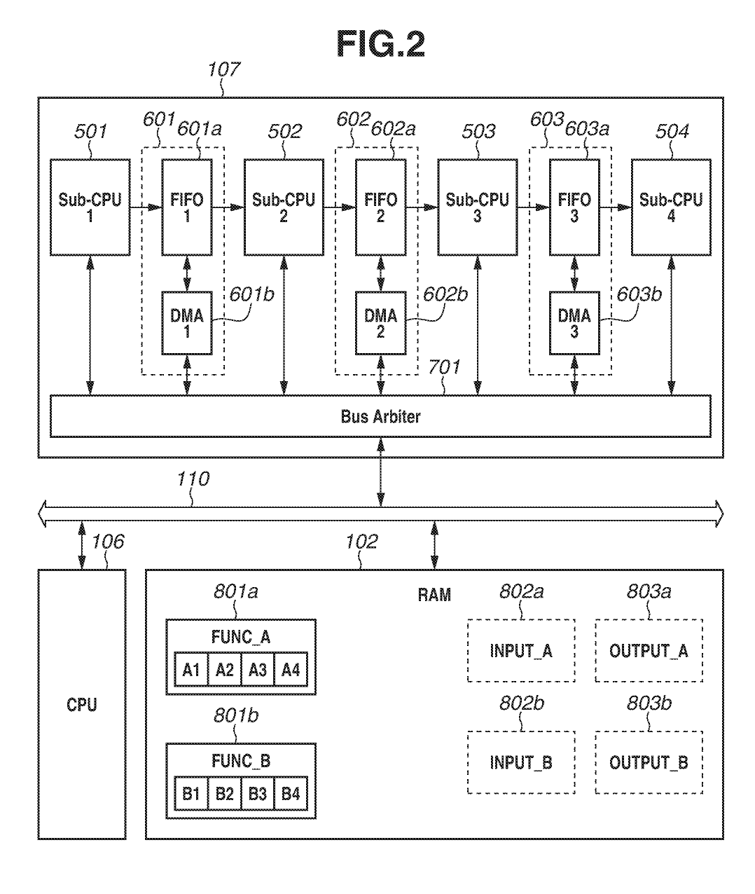

FIG. 2 is a block diagram illustrating an example of the internal configuration of the general-purpose image processing unit 107 illustrated in FIG. 1. As illustrated in FIG. 2, the general-purpose image processing unit 107 includes a plurality of processors 501 to 504, which form a pipeline or a sequential chain. The sub-CPUs 1, 2, 3, and 4 may also form parallel branches and operate independently. In the example of FIG. 2, the general-purpose image processing unit 107 includes four sub-CPUs, namely a sub-CPU 1 (501), a sub-CPU 2 (502), a sub-CPU 3 (503), and a sub-CPU 4 (504). Each of the sub-CPU 1 (501), the sub-CPU (502), the sub-CPU 3 (503), and the sub-CPU 4 (504) is a processor. A plurality of first-in-first-out buffers (FIFOs) with direct memory access controllers (DMAs) (601 to 603) are a plurality of communication units and communicate data between the plurality of sub-CPUs (501 to 504). The sub-CPU 1 (501) and the sub-CPU 2 (502) are connected together by a FIFO with a DMA 1 (601). Further, the sub-CPU 2 (502) and the sub-CPU 3 (503) are connected together by a FIFO with a DMA 2 (602). Further, the sub-CPU 3 (503) and the sub-CPU 4 (504) are connected together by a FIFO with a DMA 3 (603). Each of the FIFOs with the DMAs (601 to 603) functions as a communication unit for temporarily storing, in a FIFO-type buffer within the communication unit, communication data between processors that is transferred between an upstream sub-CPU and a downstream sub-CPU in the pipeline. Further, each of the sub-CPUs 1 to 4 (501 to 504) and the FIFOs with the DMAs 1 to 3 (601 to 603) is configured to provide input and output to the system bus 110. That is, a bus transaction issued by each of these blocks is mediated by a bus arbiter 701 within the general-purpose image processing unit 107 and then issued as memory access to the RAM 102, which is connected to the blocks via the system bus 110.

Each of the sub-CPUs (501 to 504) executes a plurality of programs (or functions) 801a and 801b, which are stored in a system memory of the RAM 102, by switching the plurality of programs (or functions) 801a and 801b in a time-sharing manner, thereby executing a partial process of each function such as a function A or B. At this time, each of the sub-CPUs (501 to 504) acquires input data 802a or 802b, which is stored in the system memory of the RAM 102, thereby obtaining input data for executing each function such as the function A or B. Similarly, each of the sub-CPUs (501 to 504) stores output data obtained by executing each function such as the function A or B, as data 803a or 803b on the system memory of the RAM 102.

The FIFO with the DMA 1 (601) includes a FIFO 1 (601a) and a DMA 1 (601b). The FIFO with the DMA 2 (602) includes a FIFO 2 (602a) and a DMA 2 (602b). The FIFO with the DMA 3 (603) includes a FIFO 3 (603a) and a DMA 3 (603b). The FIFOs (601a to 603a) are FIFO buffers, and the DMAs (601b to 603b) are DMA controllers. Each of the FIFOs (601a to 603a) is provided between the plurality of sub-CPUs (501 to 504). Each of the DMAs (601b to 603b) performs direct memory access to the RAM 102.

The bus arbiter 701 is a first bus and is connected to the plurality of sub-CPUs (501 to 504), the DMAs (601b to 603b), and the system bus 110. The system bus 110 is a second bus and is connected to the bus arbiter 701 and the CPU 106. The RAM 102 is connected to the system bus 110.

According to an instruction from the CPU 106, each of the FIFOs with the DMAs (601 to 603) transmits communication data received from an upstream processor to a downstream processor via the FIFO (601a to 603a). Further, according to an instruction from the CPU 106, each of the FIFOs with the DMAs (601 to 603) temporarily holds, in a buffer area on the system memory of the RAM 102, communication data received from the upstream processor via the DMA (601b to 603b) by a FIFO interface. Further, each of the FIFOs with the DMAs (601 to 603) transmits the communication data temporarily held in the buffer area on the system memory of the RAM 102 to the downstream processor via the DMA (601b to 603b) again, using the FIFO interface. At this time, a buffer area within the FIFO (601a to 603a) used in a data path via the FIFO is generally composed of a static random-access memory (SRAM) in a relatively small size and often used in a fixed size (e.g., a 64-bit×32-stage FIFO). Further, a buffer area within the RAM 102 used in a data path via the DMA is generally composed of a DRAM in a relatively large size and often used by reserving a partial area of the DRAM in a variable size (e.g., equivalent to a 64-bit×4096-stage FIFO). The configuration illustrated in FIG. 2 is an example of a sub-system using a plurality of processors forming a pipeline, and does not limit the number of processors and a connection configuration.

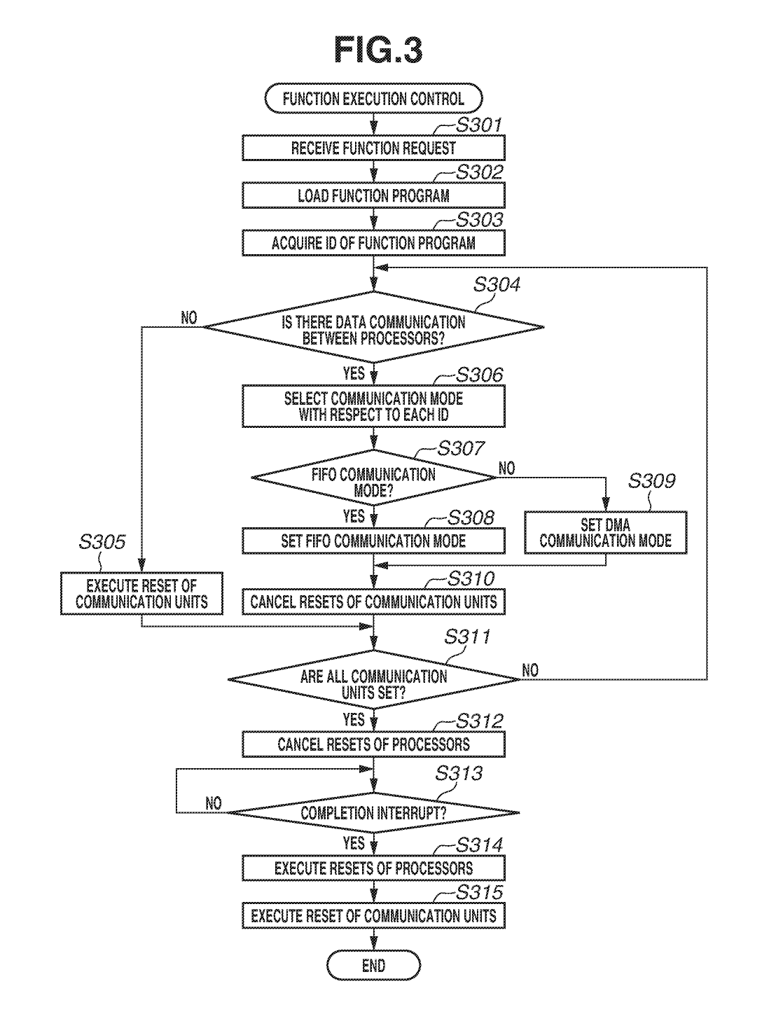

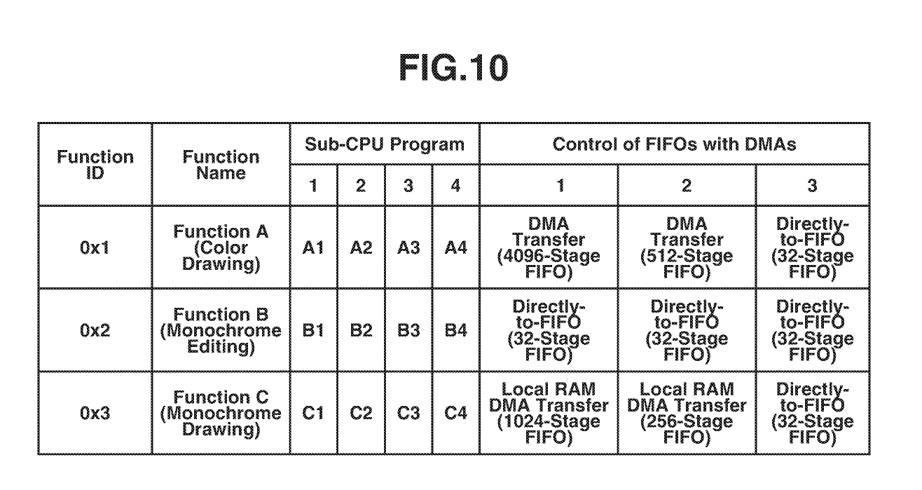

FIG. 3 is a flowchart illustrating the flow in which the CPU 106 controls the execution of a function by the general-purpose image processing unit 107 in the first exemplary embodiment. A program for steps S301 to S315 described in the flowchart in FIG. 3 is loaded into the RAM 102 and executed by the CPU 106 when the image processing apparatus 10 is started. Further, FIG. 10 is a table for managing sub-CPU processing programs for a plurality of functions that can be achieved by the general-purpose image processing unit 107, and a method for controlling the FIFOs with the DMAs in the present exemplary embodiment. Steps S301 to S315 in FIG. 3 are described with reference to the example of FIG. 10, where necessary.

First, in step S301, with respect to each job received by the image processing apparatus 10, the CPU 106 acquires a function request made to the general-purpose image processing unit 107. For example, in a case where a request to execute a job of a color PDL printing process is made, the CPU 106 controls the general-purpose image processing unit 107 to execute programs for achieving a color drawing (RIP) function as the function A determined in advance for the general-purpose image processing unit 107. Further, for example, in a case where a request to execute a job of a monochrome copying process is made, the CPU 106 controls the general-purpose image processing unit 107 to execute programs for achieving a monochrome editing function as the function B determined in advance for the general-purpose image processing unit 107.

Next, in step S302, the CPU 106 loads the programs for each function associated in step S301 into the sub-CPUs (501 to 504). That is, if the color drawing (RIP) function of the function A is selected, the CPU 106 loads programs A1 to A4 of the processing program 801a, which corresponds to the function A. Further, if the monochrome editing function of the function B is selected, the CPU 106 loads programs B1 to B4 of the processing program 801b, which corresponds to the function B. By the above loading, the CPU 106 assigns functions to the plurality of sub-CPUs (501 to 504).

Next, in step S303, the CPU 106 acquires a function identification (ID) for identifying the programs corresponding to the function to be achieved by the general-purpose image processing unit 107. For example, if the color drawing (RIP) function of the function A illustrated in FIG. 10 is selected, and the sub-CPU programs A1 to A4, which correspond to the function A, are loaded into the sub-CPUs (501 to 504) in step S302, the CPU 106 acquires a function ID=0x1, which indicates the sub-CPU programs A1 to A4. Further, for example, if the monochrome editing function of the function B illustrated in FIG. 10 is selected, and the sub-CPU programs B1 to B4, which correspond to the function B, are loaded into the sub-CPUs (501 to 504) in step S302, the CPU 106 acquires a function ID=0x2, which indicates the sub-CPU programs B1 to B4

Next, in step S304, the CPU 106 determines whether data is to be communicated between processors. If a single function is to be achieved by partial processes performed by two or more processors connected together by the pipeline, and parallel processing is to be executed while communication data such as image data and a control command is transferred between the processors (YES in step S304), the processing proceeds to step S306. If, on the other hand, a single function is to be achieved by a process complete in a single processor, or parallel processing is to be achieved without transferring communication data such as image data and a control command between processors (NO in step S304), the processing proceeds to step S305.

In step S305, since data communication is not required using the FIFOs with the DMAs between the processors, the CPU 106 executes reset control of the FIFOs with the DMAs, which are the communication units between the processors, and the processing proceeds to step S311.

In step S306, for each of the FIFOs with the DMAs, which are the communication units between the processors, the CPU 106 selects (sets) a communication mode corresponding to the function ID acquired in step S303. The communication mode includes a DMA transfer communication mode (a first communication mode) and a directly-to-FIFO communication mode (a second communication mode). Next, in step S307, the CPU 106 determines whether the communication mode selected in step S306 is the directly-to-FIFO communication mode. If it is determined that the communication mode is the directly-to-FIFO communication mode (YES in step S307), the processing proceeds to step S308. Further, if it is determined that the communication mode is the DMA transfer communication mode (NO in step S307), the processing proceeds to step S309.

In step S308, the CPU 106 sets the directly-to-FIFO communication mode, and the processing proceeds to step S310. Specifically, the CPU 106 establishes a data path from an upstream processor to a downstream processor via a FIFO composed of an SRAM in a fixed size and a relatively small size (e.g., a 64-bit×32-stage FIFO). That is, in the directly-to-FIFO communication mode, the CPU 106 performs control to communicate data between the processors, using the buffer areas within the FIFOs (601a to 603a) described in FIG. 2.

In step S309, the CPU 106 sets the DMA transfer communication mode, and the processing proceeds to step S310. Specifically, the CPU 106 establishes a data path from an upstream processor to a downstream processor via a DMA composed of a DRAM in a variable size and a relatively large size. That is, in the DMA transfer communication mode, the CPU 106 performs control to communicate data between the processors, using as a buffer area the partial area reserved within the RAM 102 as described in FIG. 2.

For example, if acquiring the function ID=Oxl illustrated in FIG. 10 in step S303, the CPU 106 sets the FIFOs with the DMAs 1 and 2 (601 and 602) illustrated in FIG. 2 to the DMA transfer communication mode and sets the FIFO with the DMA 3 (603) to the directly-to-FIFO communication mode. Further, for example, if acquiring the function ID=0x2 illustrated in FIG. 10 in step S303, the CPU 106 sets the FIFOs with the DMAs 1 to 3 (601 to 603) illustrated in FIG. 2 to the directly-to-FIFO communication mode.

In step S309, the CPU 106 sets a DMA transfer destination address and a DMA transfer destination buffer size for each of the FIFOs with the DMAs (601 to 603), thereby reserving a buffer area in the system memory of the RAM 102. In the DMA transfer communication mode, the CPU 106 also sets the size of the buffer area to be reserved on the DRAM and thereby can also set the buffer size itself to any variable size. That is, for example, in the case of the function ID=0x1 illustrated in FIG. 10, the CPU 106 can set a buffer area between the sub-CPU 1 (501) and the sub-CPU 2 (502) to be equivalent to a 64-bit×4096-stage FIFO. On the other hand, for example, in the case of the function ID=0x1 illustrated in FIG. 10, the CPU 106 can set a buffer area between the sub-CPU 2 (502) and the sub-CPU 3 (503) to be equivalent to a 64-bit×512-stage FIFO.

In step S310, the CPU 106 cancels the resets of the FIFOs with the DMAs, which are the communication units, and performs standby control so that the FIFOs with the DMAs wait for the sub-CPUs of the general-purpose image processing unit 107 to execute the programs.

Next, in step S311, the CPU 106 determines whether the FIFOs with the DMAs of all the communication units included in the general-purpose image processing unit 107 are set. If it is determined that all the communication units are set (YES in step S311), the processing proceeds to step S312. If it is determined that not all the communication units are set (NO in step S311), the processing returns to step S304. That is, the CPU 106 repeats steps S304 to S310 until the settings of all the FIFOs with the DMAs are completed (NO in step S311). After the settings of the FIFOs with the DMAs of all the communication units are completed (YES in step S311), the processing proceeds to step S312.

In step S312, the CPU 106 cancels the resets of the sub-CPUs (501 to 504), and the sub-CPUs (501 to 504) of the general-purpose image processing unit 107 fetch commands of the programs on the RAM 102, thereby executing partial processes assigned to the respective sub-CPUs. Next, in step S313, the CPU 106 waits until an interrupt notification indicating the completion of execution of the function is received from the general-purpose image processing unit 107 (NO in step S313). After the interrupt notification is received (YES in step S313), the processing proceeds to step S314.

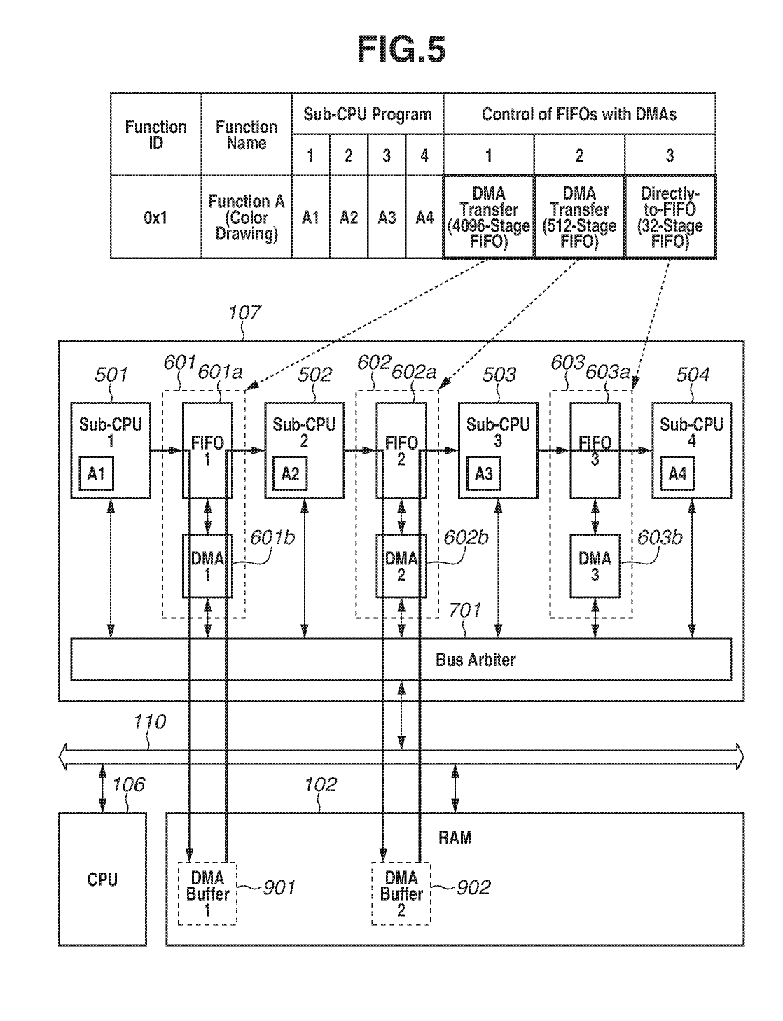

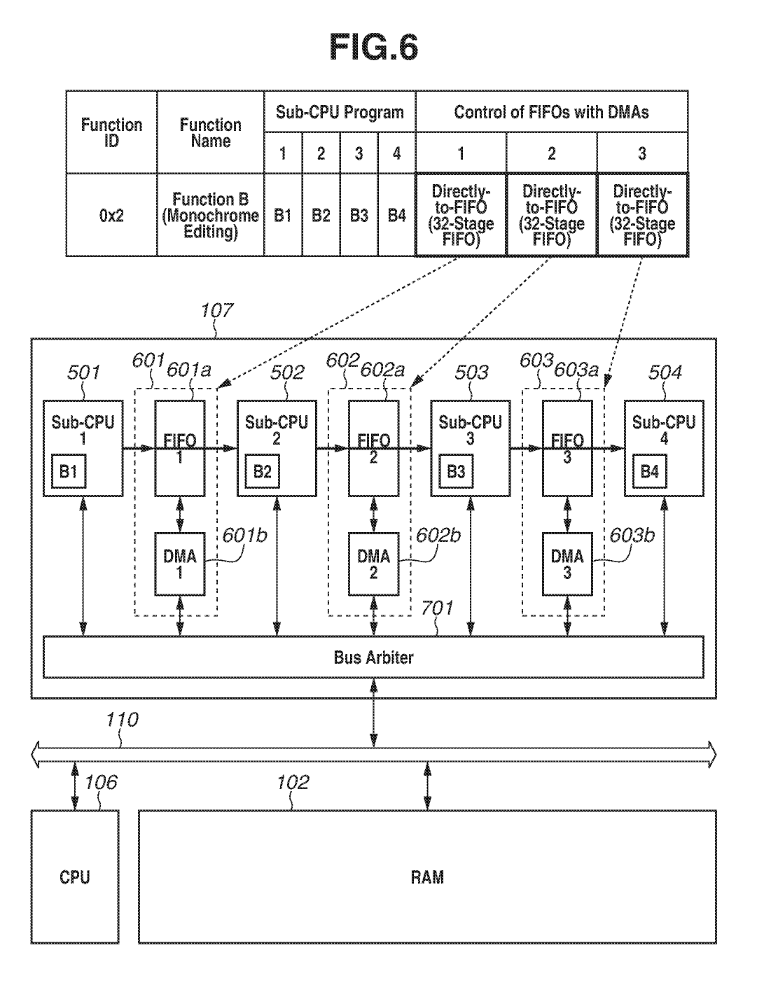

In step S314, the CPU 106 executes the resets of the sub-CPUs (501 to 504) included in the general-purpose image processing unit 107, thereby stopping the execution of the programs. Finally, in step S315, the CPU 106 executes the resets of the FIFOs with the DMAs (601 to 603) serving as the communication units between the processors included in the general-purpose image processing unit 107, thereby initializing the buffer areas used by the general-purpose image processing unit 107 to execute the function. A direct data transfer to a FIFO and a data transfer using a DMA transfer with respect to each function ID will be described with reference to FIGS. 5 and 6.

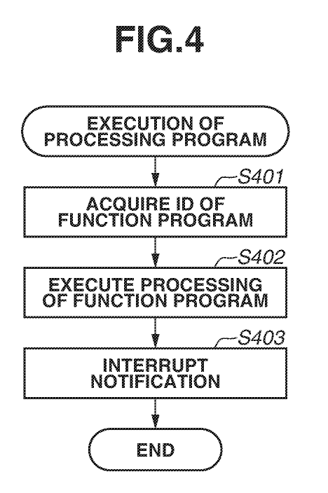

FIG. 4 is a flowchart illustrating the flow in which the general-purpose image processing unit 107 executes a function according to an instruction from the CPU 106 in the first exemplary embodiment. A program for steps S401 to S403 described in the flowchart in FIG. 4 is loaded into the RAM 102 and executed by the sub-CPUs (501 to 504) when the image processing apparatus 10 is started. Further, FIG. 10 is a table for managing sub-CPU processing programs for a plurality of functions that can be achieved by the general-purpose image processing unit 107, and a method for controlling the FIFOs with the DMAs in the present exemplary embodiment. Steps S401 to S403 in FIG. 4 are described with reference to the example of FIG. 10, where necessary.

First, in step S401, the sub-CPUs (501 to 504) acquire the function ID of the function to be executed by the programs loaded onto the RAM 102 by the CPU 106 in step S302. As these programs, a plurality of programs may be prepared for a plurality of functions, or a single program in which a plurality of modes are implemented in advance may branch with respect to each function ID. At this time, in a case where a plurality of programs are prepared, the plurality of programs may be stored in advance in different memory areas (e.g., 801a and 801b) on the RAM 102, and the CPU 106 may perform control by switching the reference destination address of the sub-CPUs (501 to 504) with respect to each function ID. Alternatively, in a case where a plurality of programs are prepared, a fixed memory area (e.g., 801a) on the RAM 102 may be set as the reference destination address of the sub-CPUs (501 to 504), and then, the CPU 106 may perform control by rewriting a program to be stored with respect to each function ID. Yet alternatively, the CPU 106 may switch operation modes in a program in which a plurality of modes are implemented in advance for the sub-CPUs (501 to 504), thereby performing control by switching, in a time-sharing manner, programs to be assigned to the sub-CPUs (501 to 504). On the other hand, in a case where a single program branches with respect to each function ID, the sub-CPUs (501 to 504) acquire a function ID set in an internal register (not illustrated) of the general-purpose image processing unit 107 or a predetermined address area on the RAM 102 by the CPU 106.

Next, in step S402, the sub-CPUs (501 to 504) execute the programs for partial processes assigned to each function. That is, for example, in the case of the function ID=0x1, each of the sub-CPUs (501 to 504) executes the color drawing (RIP) function of the function A. In the case of the function ID=0x2, each of the sub-CPUs (501 to 504) executes the monochrome editing function of the function B.

Next, in step S403, after the programs for the partial processes assigned to each function end, the sub-CPUs (501 to 504) give interrupt notifications to the CPU 106. As the interrupt notifications given to the CPU 106 by the sub-CPUs (501 to 504), as many interrupt notifications as the number of processors used among the sub-CPUs may be given, or an interrupt notification may be given only by a representative processor of the sub-CPUs (501 to 504). Then, the interrupt notifications given by the sub-CPU (501 to 504) in step S403 are detected by the CPU 106 in step S313.

FIGS. 5 and 6 are conceptual diagrams illustrating communication control methods for the FIFOs with the DMAs in cases where the execution of the functions A and B is controlled in the first exemplary embodiment. As illustrated in FIG. 5, in an example of the color drawing (RIP) function of the function A, in data transfers between the processors connected by the pipeline, control may be performed to set a communication mode by combining the DMA transfer communication mode and the directly-to-FIFO communication mode. That is, the CPU 106 sets the FIFOs with the DMAs 1 and 2 (601 and 602) to the DMA transfer communication mode and sets the FIFO with the DMA 3 (603) to the directly-to-FIFO communication mode. The reason for this is that in a PDL data drawing process, image data in a vector format is treated as input data, and image data in a raster format is treated as output data. That is, in image data in a vector format, each of drawing objects such as a character, a photograph, and graphics has drawing position coordinates in a page and superimposition information regarding superimposition between objects. Thus, the relative magnitude relationship between feature amounts changes depending on data to be treated. Specifically, for example, in a case where processes having different characteristics, such as an edge process, a level process, a filter process, and a composite process, are assigned to the respective processors 501 to 504, a feature amount such as an edge or a level tends to increase. In response, taking into account buffer capacity required when the processing of each processor is performed, a DMA transfer using a relatively large buffer and a FIFO transfer using a relatively small buffer are combined, whereby it is possible to deal with a change in buffer capacity required during processing per unit area (e.g., a single line). That is, particularly in a case where relatively large buffer capacity is required between the processors, buffer areas (901 and 902) within the RAM 102 may be reserved so that buffer capacity has an optimal balance according to the amount of data to be transferred between the processors.

The size of each buffer area (901 and 902) of the RAM 102 is larger than the size of each FIFO (601a to 603a). The CPU 106 sets the communication mode according to the amount of data to be communicated between the plurality of sub-CPUs (501 to 504). For example, in a case where the amount of data to be communicated between the plurality of sub-CPUs (501 to 504) is greater than a threshold, the CPU 106 sets the DMA transfer communication mode. Further, in a case where the amount of data to be communicated between the plurality of sub-CPUs (501 to 504) is smaller than the threshold, the CPU 106 sets the directly-to-FIFO communication mode.

First, the DMA transfer communication mode of the FIFO with the DMA 1 (601) is described. The FIFO 1 (601a) receives communication data from the upstream sub-CPU 1 (501). The DMA 1 (601b) temporarily holds the communication data received by the FIFO 1 (601a) in a DMA buffer area 1 (901) of the RAM 102. Further, the DMA 1 (601b) writes the communication data temporarily held in the DMA buffer area 1 (901) of the RAM 102 to the FIFO 1 (601a) again. The FIFO 1 (601a) transmits the written communication data to the downstream sub-CPU 2 (502).

Next, the DMA transfer communication mode of the FIFO with the DMA 2 (602) is described. The FIFO 2 (602a) receives communication data from the upstream sub-CPU 2 (502). The DMA 2 (602b) temporarily holds the communication data received by the FIFO 2 (602a) in a DMA buffer area 2 (902) of the RAM 102. Further, the DMA 2 (602b) writes the communication data temporarily held in the DMA buffer area 2 (902) of the RAM 102 to the FIFO 2 (602a) again. The FIFO 2 (602a) transmits the written communication data to the downstream sub-CPU 3 (503).

Next, the directly-to-FIFO communication mode of the FIFO with the DMA 3 (603) is described. The FIFO 3 (603a) receives communication data from the upstream sub-CPU 3 (503) and transmits the received communication data to the downstream sub-CPU 4 (504) in a first-in-first-out manner.

As illustrated in FIG. 6, in an example of the monochrome editing function of the function B, in data transfers between the processors connected by the pipeline, control may be performed to set a communication mode including only the directly-to-FIFO communication mode. That is, the CPU 106 sets the FIFOs with the DMAs 1 to 3 (601 to 603) to the directly-to-FIFO communication mode. The reason for this is that in a general editing process such as a filter process or a count process, image data in a raster format is treated as input/output data. That is, in image data in a raster format, a plurality of pixels having different pixel values are included in a page. Thus, the processing content of a processor does not often change depending on the content of image data. Specifically, for example, in a case where processes having the same characteristics, such as processes on areas 1, 2, 3, and 4, which are divided as partial areas in a page, are assigned to the respective processors 501 to 504, the processing speeds of all the processors 501 to 504 tend to be uniform. In response, taking into account buffer capacity required when the processing of each processor is performed, only the directly-to-FIFO communication mode using a relatively small buffer is set, whereby it is possible to perform control so that a DMA transfer, which unnecessarily consumes the memory band of the system bus 110, is not performed.

First, the directly-to-FIFO communication mode of the FIFO with the DMA 1 (601) is described. The FIFO 1 (601a) receives communication data from the upstream sub-CPU 1 (501) and transmits the received communication data to the downstream sub-CPU 2 (502) in a first-in-first-out manner.

Next, the directly-to-FIFO communication mode of the FIFO with the DMA 2 (602) is described. The FIFO 2 (602a) receives communication data from the upstream sub-CPU 2 (502) and transmits the received communication data to the downstream sub-CPU 3 (503) in a first-in-first-out manner.

Next, the directly-to-FIFO communication mode of the FIFO with the DMA 3 (603) is described. The FIFO 3 (603a) receives communication data from the upstream sub-CPU 3 (503) and transmits the received communication data to the downstream sub-CPU 4 (504) in a first-in-first-out manner.

As described above, each of the FIFOs with the DMAs (601 to 603) buffers data in a different buffer area according to the communication mode and communicates data between the plurality of sub-CPUs (501 to 504). Specifically, in the DMA transfer communication mode, each of the FIFOs with the DMAs (601 to 603) buffers data in the DMA buffer areas (901 and 902) of the RAM 102, using the DMA (601b to 603b). Further, in the directly-to-FIFO communication mode, each of the FIFOs with the DMAs (601 to 603) buffers data in the FIFO (601a to 603a).

According to the present exemplary embodiment, control is performed by switching a data transfer method between the plurality of processors 501 to 504 according to partial processes assigned to each function to be achieved by the processors 501 to 504, whereby it is possible to improve system performance. Particularly, according to the present exemplary embodiment, even in a case where the plurality of processors 501 to 504 execute programs for a plurality of functions by switching the programs, it is possible to improve the system performance of each function.

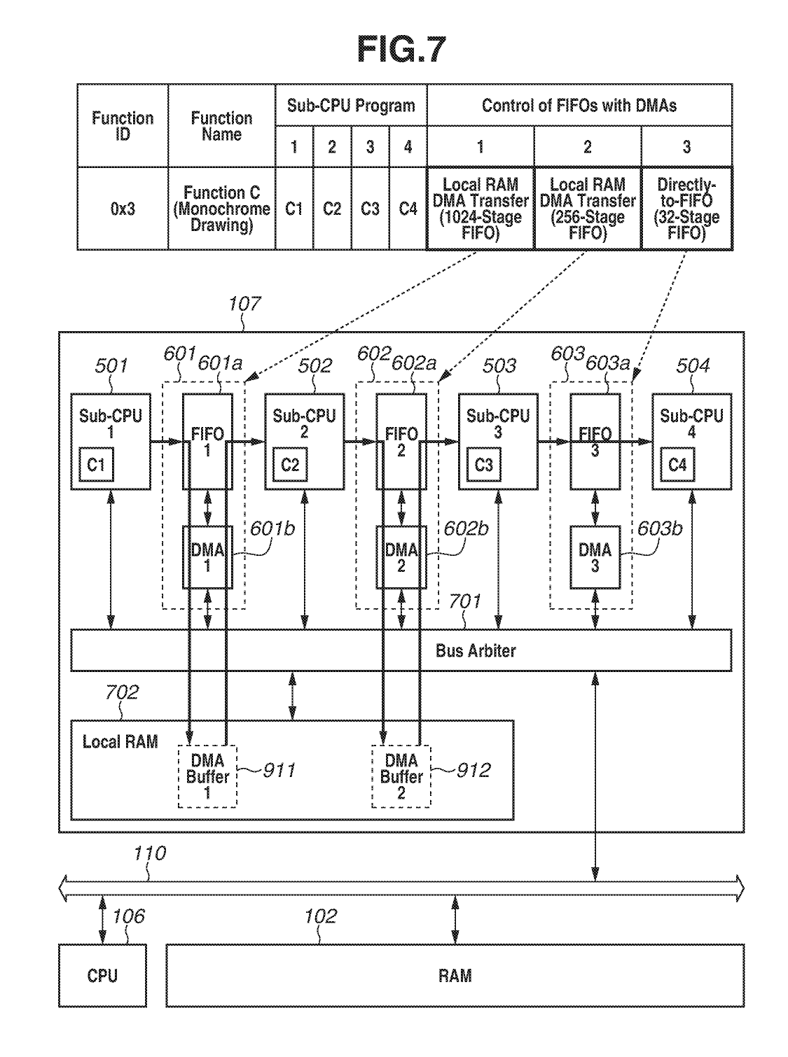

With reference to FIGS. 7 and 10, a second exemplary embodiment is described below. FIG. 7 is a conceptual diagram illustrating a communication control method for the FIFOs with the DMAs (601 to 603) in a case where the execution of a function C is controlled in the second exemplary embodiment. The difference between the second exemplary embodiment and the first exemplary embodiment is described below. As illustrated in FIG. 7, in the second exemplary embodiment, the general-purpose image processing unit 107 described with reference to FIG. 2 has a configuration in which a local RAM (volatile memory) 702 is further connected to the bus arbiter 701. In this configuration, each of the sub-CPUs (501 to 504) and the FIFOs with the DMAs (601 to 603) can access the local RAM 702 and can also access the system memory of the RAM 102 via the system bus 110. In an example of a monochrome drawing (RIP) function of the function C in FIG. 10, the FIFOs with the DMAs (601 and 602) temporarily hold communication data between the processors 501 to 503 by a DMA transfer, using the local RAM 702 instead of the system memory of the RAM 102. At this time, the DMA transfer method using the local RAM 702 is similar to that in the flowchart described with reference to FIG. 3, and therefore is not described here. In step S309, when setting a DMA transfer destination address and a DMA transfer destination buffer size for each of the FIFOs with the DMAs (601 to 603), the CPU 106 may set the DMA transfer destination address and the DMA transfer destination buffer size to buffer areas (911 and 912) within the local RAM 702. Each of the buffer areas within the local RAM 702 used in a data path for a DMA transfer is composed of an SRAM in a size larger than that of each of the FIFOs (601a to 603c) and smaller than that of the RAM 102 and is often used by reserving a partial area of the SRAM in a variable size.

The FIFO with the DMA 1 (601) is set to the DMA transfer communication mode by the CPU 106. The FIFO 1 (601a) receives communication data from the upstream sub-CPU 1 (501). The DMA 1 (601b) temporarily holds the communication data received by the FIFO 1 (601a) in a DMA buffer area 1 (911) of the local RAM 702. Further, the DMA 1 (601b) writes the communication data temporarily held in the DMA buffer area 1 (911) of the local RAM 702 to the FIFO 1 (601a) again. The FIFO 1 (601a) transmits the written communication data to the downstream sub-CPU 2 (502).

The FIFO with the DMA 2 (602) is set to the DMA transfer communication mode by the CPU 106. The FIFO 2 (602a) receives communication data from the upstream sub-CPU 2 (502). The DMA 2 (602b) temporarily holds the communication data received by the FIFO 2 (602a) in a DMA buffer area 2 (912) of the local RAM 702. Further, the DMA 2 (602b) writes the communication data temporarily held in the DMA buffer area 2 (912) of the local RAM 702 to the FIFO 2 (602a) again. The FIFO 2 (602a) transmits the written communication data to the downstream sub-CPU 3 (503).

The FIFO with the DMA 3 (603) is set to the directly-to-FIFO communication mode by the CPU 106. The FIFO 3 (603a) receives communication data from the upstream sub-CPU 3 (503) and transmits the received communication data to the downstream sub-CPU 4 (504) in a first-in-first-out manner.

As described above, according to the second exemplary embodiment, a DMA transfer communication mode between the processors 501 to 504 using the local RAM 702 instead of the RAM 102 is provided. Consequently, it is possible to improve system performance without straining the memory band of the system bus 110.

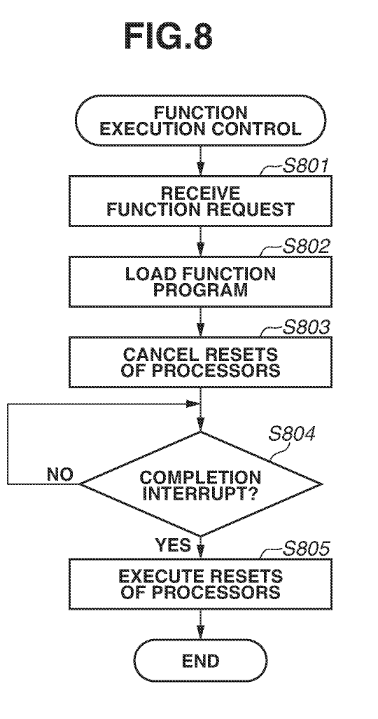

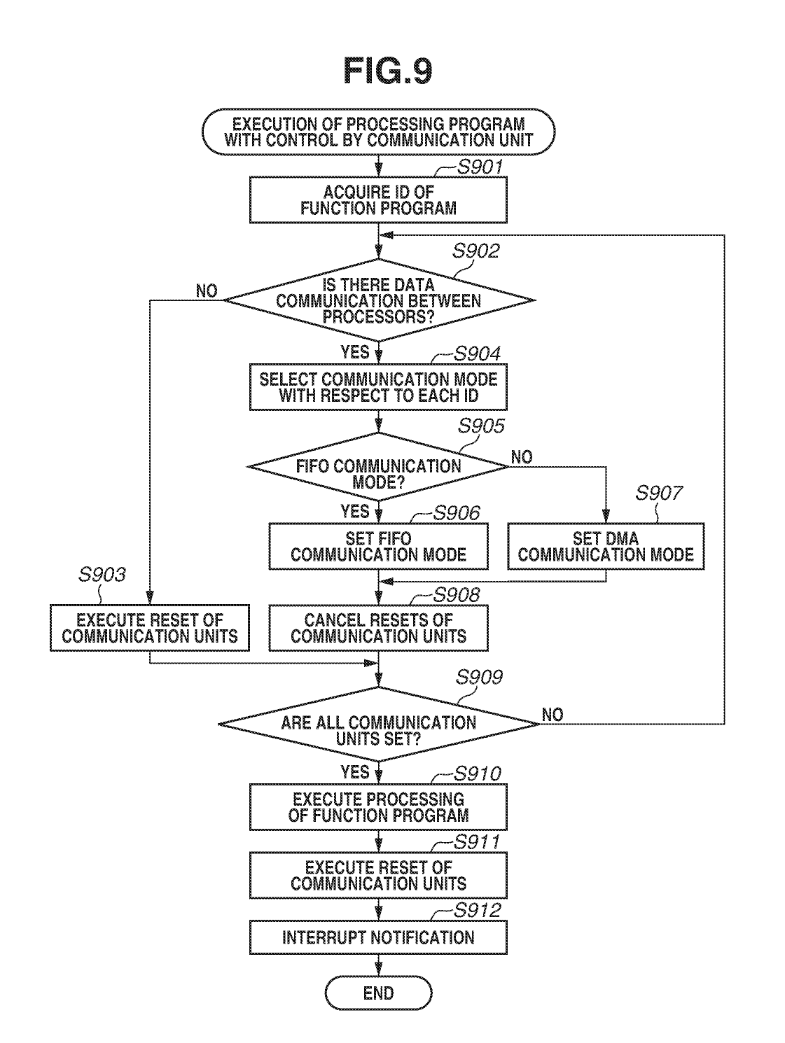

With reference to FIGS. 8 and 9, a third exemplary embodiment is described below. In the third exemplary embodiment, when the CPU 106 controls the execution of a function by the general-purpose image processing unit 107, the sub-CPUs (501 to 504) instead of the CPU 106 control the FIFOs with the DMAs (601 to 603). The differences between the present exemplary embodiment and the first and second exemplary embodiments are described below. FIGS. 8 and 9 are variations corresponding to the flowcharts in FIGS. 3 and 4, respectively.

FIG. 8 is a flowchart illustrating the flow in which the CPU 106 controls the execution of a function by the general-purpose image processing unit 107 in the third exemplary embodiment. A program for steps S801 to S805 described in the flowchart in FIG. 8 is loaded into the RAM 102 and executed by the CPU 106 when the image processing apparatus 10 is started. First, the CPU 106 performs the processes of steps S801 and S802. Steps S801 and S802 are similar to steps S301 and S302 in FIG. 3, and therefore are not described here. Next, the CPU 106 performs the processes of steps S803 to S805. Steps S803 to S805 are similar to steps S312 to S314 in FIG. 3, and therefore are not described here. That is, the flowchart in FIG. 8 is obtained by removing steps S303 to S311 included in the flowchart in FIG. 3.

FIG. 9 is a flowchart illustrating the flow in which the general-purpose image processing unit 107 executes a function according to an instruction from the CPU 106 in the third exemplary embodiment. A program for steps S901 to S912 described in the flowchart in FIG. 9 is loaded into the RAM 102 and executed by the sub-CPUs (501 to 504) when the image processing apparatus 10 is started. In steps S901 to S909, the sub-CPUs (501 to 504) execute steps similar to steps S303 to S311 performed by the CPU 106, which are described with reference to FIG. 3. That is, by steps S901 to S909, the sub-CPUs (501 to 504) instead of the CPU 106 set the communication mode of the FIFOs with the DMAs (601 to 603) with respect to each function ID and then cancel the resets of the FIFOs with the DMAs (601 to 603). Next, in step S910, similarly to step S402 in FIG. 4, the sub-CPUs (501 to 504) execute the programs for partial processes assigned to each function. Next, in step S911, similarly to step S315 in FIG. 3, the sub-CPUs (501 to 504) execute the resets of the FIFOs with the DMAs (601 to 603), thereby initializing the buffer areas used by the general-purpose image processing unit 107 to execute the function. Finally, in step S912, similarly to step S403 in FIG. 4, after the programs for the partial processes assigned to each function end, the sub-CPUs (501 to 504) give interrupt notifications to the CPU 106.

As described above, according to the third exemplary embodiment, the sub-CPUs (501 to 504) instead of the CPU 106 provide a method for controlling the communication mode between the processors 501 to 504. Consequently, it is possible to improve system performance while reducing a processing load related to the control of the CPU 106.

According to the first to third exemplary embodiments, control is performed by switching a data transfer method between the plurality of sub-CPUs (501 to 504) according to partial processes assigned to each function to be achieved by the sub-CPUs (501 to 504), whereby it is possible to improve system performance. Particularly, even in a case where the plurality of sub-CPUs (501 to 504) execute programs for a plurality of functions by switching the programs, it is possible to improve the system performance of each function.

The relative magnitude relationship between the time required until a processor at a previous stage transmits a command and the time required until a processor at a subsequent stage receives the command changes depending on the processing time of a program for executing a partial process assigned to each processor for processing target data. For example, in a case where the processing time of the processor at the previous stage is shorter than the processing time of the processor at the subsequent stage, a FIFO buffer between the processors enters a full state, and a processing waiting time (a stall) occurs in the processor at the previous stage. Conversely, in a case where the processing time of the processor at the previous stage is longer than the processing time of the processor at the subsequent stage, the FIFO buffer between the processors enters an empty state, and a processing waiting time (a stall) occurs in the processor at the subsequent stage. The present exemplary embodiment can provide an efficient system by eliminating these problems.

To address these problems, according to the present exemplary embodiment, it is possible to appropriately control communication between a plurality of processors.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-248960, filed Dec. 22, 2016, which is hereby incorporated by reference herein in its entirety.

What is claimed is:

1. An information processing apparatus comprising:
a plurality of processors forming a pipeline;
a communication unit configured to communicate data between the plurality of processors; and
a control unit configured to assign a function to the plurality of processors,
wherein the control unit or the processors set a communication mode according to the function, and
wherein the communication unit buffers the data in different buffer areas according to the communication mode, thereby communicating the data between the plurality of processors.

2. The information processing apparatus according to claim 1,
wherein the communication unit includes:
a first-in-first-out (FIFO) buffer provided between the plurality of processors; and
a direct memory access (DMA) controller configured to perform direct memory access to a memory,
wherein the control unit or the processors set a first communication mode or a second communication mode according to the function, and
wherein in the first communication mode, the communication unit buffers the data in a buffer area of the memory using the DMA controller, and in the second communication mode, the communication unit buffers the data in the FIFO buffer.

3. The information processing apparatus according to claim 2, further comprising:
a first bus connected to the plurality of processors and the DMA controller; and
a second bus connected to the first bus and the control unit,
wherein the memory is connected to the second bus.

4. The information processing apparatus according to claim 2, further comprising:
a first bus connected to the plurality of processors and the DMA controller; and
a second bus connected to the first bus and the control unit,
wherein the memory is connected to the first bus.

5. The information processing apparatus according to claim 2, wherein the control unit sets the first communication mode or the second communication mode according to the function, and in the first communication mode, reserves the buffer area of the memory.

6. The information processing apparatus according to claim 2, wherein the processors set the first communication mode or the second communication mode according to the function, and in the first communication mode, reserve the buffer area of the memory.

7. The information processing apparatus according to claim 2, wherein a size of the buffer area of the memory is larger than a size of the FIFO buffer.

8. The information processing apparatus according to claim 1, wherein the control unit or the processors set the communication mode according to an amount of data to be communicated between the plurality of processors.

9. The information processing apparatus according to claim 2, wherein in a case where an amount of data to be communicated between the plurality of processors is larger than a threshold, the control unit or the processors set the first communication mode, and in a case where the amount of data to be communicated between the plurality of processors is smaller than the threshold, the control unit or the processors set the second communication mode.

10. The information processing apparatus according to claim 1, wherein the plurality of processors execute the function by switching the function in a time-sharing manner.

11. A communication control method for an information processing apparatus including:
a plurality of processors forming a pipeline;
a communication unit configured to communicate data between the plurality of processors; and
a control unit configured to assign a function to the plurality of processors,
the communication control method comprising:
setting a communication mode according to the function; and
buffering the data in different buffer areas according to the communication mode, thereby communicating the data between the plurality of processors.
